(19) United States
(12) Patent Application Publication
(10) Pub. No.: US 2014/0291345 A1
(43) Pub. Date: Oct. 2, 2014

(54) DISPENSING DEVICE IN VENDING MACHINE

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: CHAO LIU, Wuhan (CN); ZHI-PING WU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/060,775

(22) Filed: Oct. 23, 2013

(30) Foreign Application Priority Data
Mar. 29, 2013 (CN) 2013101072197

(51) Int. Cl. G07F 11/24

(52) U.S. Cl. CPC G07F 11/24
USPC 221/195

(57) ABSTRACT

A dispensing device includes a cabinet and a dispensing module. The cabinet includes a bottom plate for holding a number of products and defines a product channel. The dispensing module includes a first blocking plate rotatably mounted to the cabinet. An obtuse angle is defined between the bottom plate and a direction of gravity. The first blocking plate is rotatable relative to the cabinet between an initial position and a dispensing position. When the first blocking plate is in the initial position, the first blocking plate blocks the products from sliding out of the product channel. When the first blocking plate is in the dispensing position, the product channel is open to allow the products to slide out of the product channel.

### BACKGROUND

1. Technical Field

The present disclosure relates to vending machines, and particularly to a dispensing device in the vending machines.

2. Description of Related Art

In many direct-type vending machines, a dispensing devices includes a number of product boxes. Each product box defines a product channel for receiving products and includes a blocking plate for preventing products from falling out of the product channel when the product is not selected. When the blocking plate is located below the products, after one product is dropped down to an opening for the customer, the unpurchased products drop down together onto the blocking plate, which may damage the blocking plate. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an assembled, isometric view of one embodiment of a dispensing device of a vending machine in an initial position.

FIG. 2 is similar to FIG. 1, but viewed from a different aspect.

FIG. 3 is another assembled, isometric view of the dispensing device in an operation position.

FIG. 4 is similar to FIG. 3, but viewed from a different aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

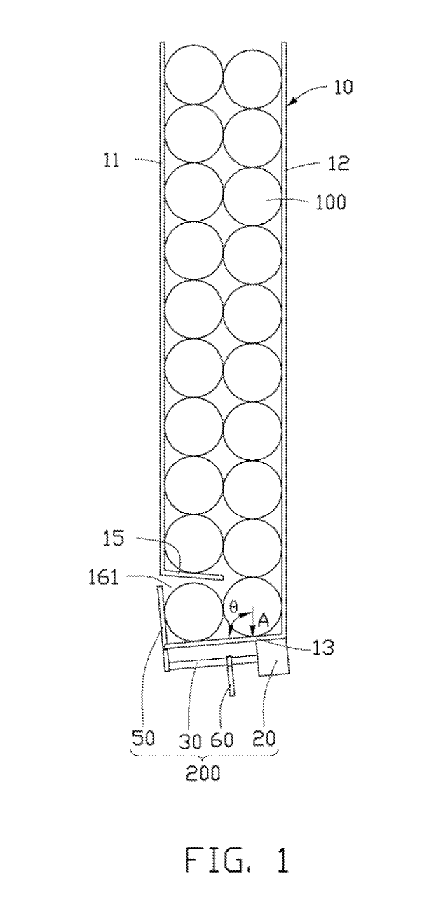

FIG. 1 shows one embodiment of a dispensing device in a vending machine. The dispensing device includes a cabinet 10 and a dispensing module 200. A plurality of products 100 is received in the cabinet 10.

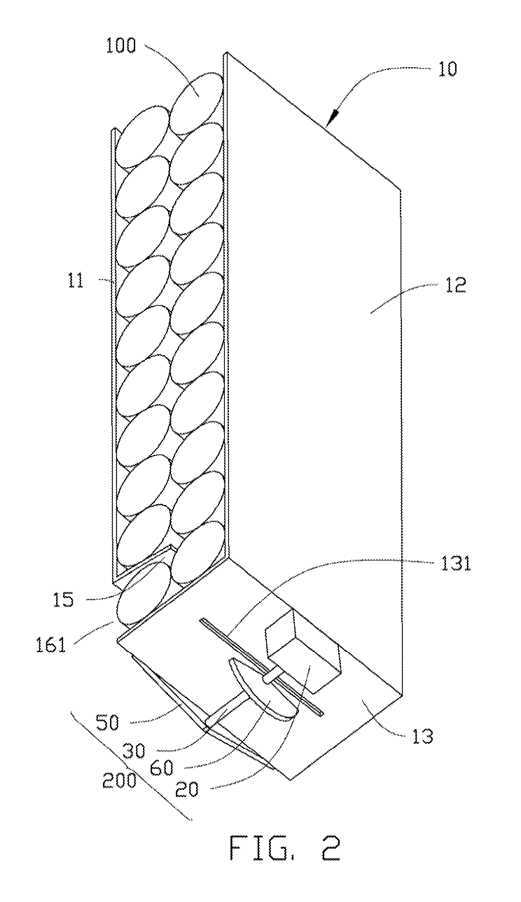

FIGS. 1 and 2 show that the cabinet 10 includes a first side plate 11, a second side plate 12, and a bottom plate 13. In one embodiment, the first side plate 11 is substantially parallel to the second side plate 12. A length of the second side plate 12 is greater than a length of the first side plate 11. A limiting plate 15 extends slantingly from a bottom edge of the first side plate 11 towards the second side plate 12, such that an obtuse angle is formed between the limiting plate 15 and the first side plate 11. A distance between a distal end of the limiting plate 15 and the first side plate 11 is substantially equal to a distance between the distal end of the limiting plate 15 and the second side plate 12. The bottom plate 13 extends slantingly from a bottom edge of the second side plate 12 towards the first side plate 11. An obtuse angle is defined between the bottom plate 13 and the second side plate 12.

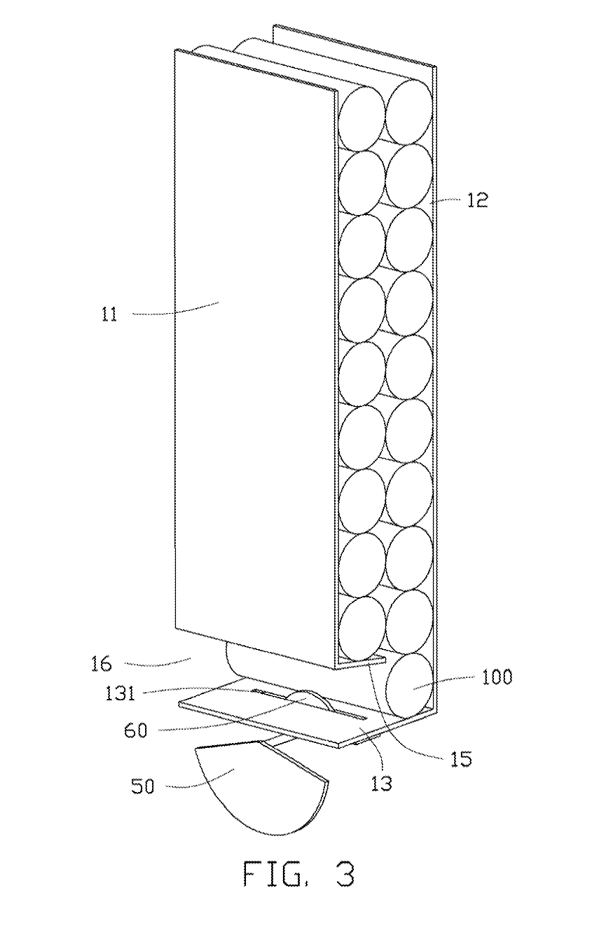

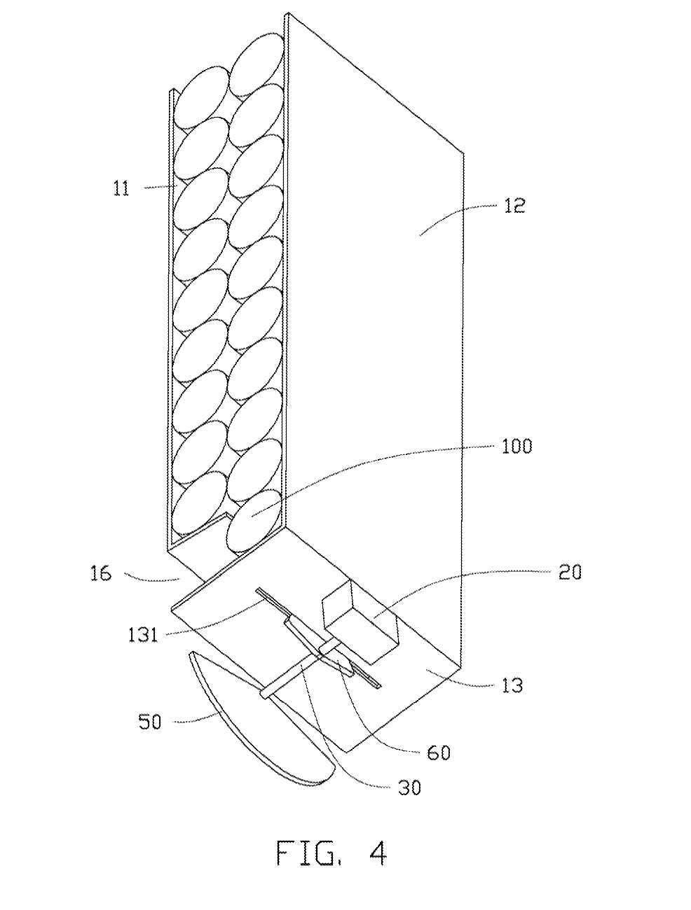

A product channel 16 (shown in FIGS. 3 and 4) is defined between the limiting plate 15 and the bottom plate 13 for the products 100 to slide out of. The product channel 16 defines an exit port 161. Two products 100 are placed on the bottom plate 13, so that a first column of products 100 is stacked on the limiting plate 15, and a second column of products 100 is stacked on the bottom plate 13. The products 100 in the first column are biased to roll/slide into the second column. The products 100 are prevented from falling out of the cabinet 10 by the dispensing module 200. The bottom plate 13 defines a slot 131 (shown in FIG. 2). The slot 131 is defined in a center of the bottom plate 13.

The dispensing module 200 includes a rotating member 20, a rotating shaft 30, a first blocking plate 50, and a second blocking plate 60.

The rotating member 20 is secured to a bottom surface of the bottom plate 13 and is operable to rotate the rotating shaft 30. In one embodiment, the rotating member 20 is a motor.

A first end of the rotating shaft 30 is secured to the rotating member 20 to be rotated by the rotating member 20. In one embodiment, the rotating shaft 30 is substantially parallel to the bottom plate 13.

The first blocking plate 50 is secured to a second end of the rotating shaft 30. In one embodiment, the first blocking plate 50 is sectorial.

The second blocking plate 60 is secured to the rotating shaft 30 and is located between the first blocking plate 50 and the rotating member 20. In one embodiment, the second blocking plate 60 is sectorial.

The first blocking plate 50 and the second blocking plate 60 extend out from opposite sides of the rotating shaft 30, respectively. In one embodiment, the first blocking plate 50 is substantially parallel to the second blocking plate 60 and is substantially perpendicular to the bottom plate 13. A distance between the first blocking plate 50 and the second blocking plate 60 is substantially equal to a width of each product 100.

In an initial position, the first blocking plate 50 extends up from the bottom plate 13 to block the products 100 from falling out of the cabinet 10, and the second blocking plate 60 extends down from the slot 131. The second blocking plate 60 is aligned with the slot 131.

When a product 100 is purchased, the rotating member 20 rotates the rotating shaft 30 180 degrees. The first blocking plate 50 and the second blocking plate 60 are rotated 180 degrees along with the rotating shaft 30. In an operation position, the first blocking plate 50 extends down from the bottom plate 13 to open the product channel 16, the purchased product 100 adjacent to the product channel 16 slides out of the product channel 16 due to gravity, and the second blocking plate 60 extends through the slot 131 to block the other products 100 from sliding out of the product channel 16. An obtuse angle θ is formed between the bottom plate 13 and a direction of gravity A (shown in FIG. 1).

After the product 100 slides out of the product channel 16, the rotating member 20 rotates the rotating shaft 30 180 degrees to return the first blocking plate 50 and the second blocking plate 60 to the initial position. After the first blocking plate 50 and the second blocking plate 60 are returned to the original position, another product 100 slides to abut the first blocking plate 50.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A dispensing device of a plurality of products, comprising:
a cabinet configured for receiving the plurality of products and comprising a bottom plate configured for holding the plurality of products; and the cabinet defining a goods channel with an exit port; and
a dispensing module comprising a first blocking plate rotatably mounted to the cabinet;
wherein an obtuse angle is defined between the bottom plate and a direction of gravity; the first blocking plate is rotatable relative to the cabinet between an initial position and a dispensing position; when the first blocking plate is in the initial position, the first blocking plate extends up from the bottom plate and is configured to block the product from falling out of the exit port; and when the first blocking plate is in the dispensing position, the first blocking plate is located down from the bottom plate, allowing the products to slide out of the exit port.

2. The dispensing device of claim 1, wherein the dispensing module further comprises a second blocking plate rotatably mounted to the cabinet; when the first blocking plate is in the initial position, the second blocking plate is located below the goods channel, which is configured for allowing the products to slide to abut the first blocking plate on the bottom plate; and when the first blocking plate is in the dispensing position, a product purchased from the plurality of products is capable of sliding out of the exit port, and the second blocking plate extends to the goods channel, preventing the unpurchased products from sliding out of the exit port.

3. The dispensing device of claim 2, wherein the bottom plate defines a slot, when the first blocking plate is in the initial position, the second blocking plate is below the slot and aligned with the slot; and when the first blocking plate is in the dispensing position, the second blocking plate extends through the slot.

4. The dispensing device of claim 2, wherein the dispensing module further comprises a rotating shaft and a rotating member, the rotating member is secured to the cabinet, and the rotating shaft is rotatably mounted to the rotating member; the first blocking plate and the second blocking plate are secured to the rotating shaft; and the rotating member rotates the first blocking plate and the second blocking plate through the rotating shaft.

5. The dispensing device of claim 4, wherein the first blocking plate and the second blocking plate are located on opposite sides of the rotating shaft.

6. The dispensing device of claim 2, wherein the first blocking plate is substantially parallel to the second blocking plate.

7. The dispensing device of claim 2, wherein a distance between the blocking plate and the second blocking plate is substantially equal to a width of each of the plurality of products.

8. The dispensing device of claim 2, wherein the cabinet further comprises a first side plate and a second side plate for the placing of the plurality of products therebetween; and the bottom plate extends slantingly from the second side plate.

9. The dispensing device of claim 8, further comprising a limiting plate extending slantingly from the first side plate, wherein a first column of products is stacked on the limiting plate, a second column of products is stacked on the bottom plate, and the first column of products has a tendency to move to the second column of products.

10. The dispensing device of claim 9, wherein the limiting plate extends slantingly towards the second side plate, and an obtuse angle is defined between the limiting plate and the second side plate.

11. A dispensing device of a plurality of products, comprising:
a cabinet configured for receiving the plurality of products and comprising a bottom plate configured for holding the plurality of products; and the cabinet defining a goods channel with an exit port; and
a dispensing module comprising a first blocking plate and a second blocking plate rotatably mounted to the cabinet;
wherein an obtuse angle is defined between the bottom plate and a gravity direction; the first blocking plate is rotatable relative to the cabinet between an initial position and a dispensing position; when the first blocking plate is in the initial position, the first blocking plate extends up from the bottom plate, the second blocking plate extends down from the bottom plate, allowing the products to slide to abut the first blocking plate on the bottom plate, and the first blocking plate is configured to block the product from falling out of the exit port; and when the first blocking plate is in the dispensing position, the first blocking plate is extends down from the bottom plate, which is configured for allowing a product purchased of the plurality of products to slide out of the exit port, and the second blocking plate extends up from the bottom plate, preventing the unpurchased products from being slid to the exit port.

12. The dispensing device of claim 11, wherein the bottom plate defines a slot, when the first blocking plate is in the initial position, the second blocking plate is below the slot and aligned with the slot; and when the first blocking plate is in the dispensing position, the second blocking plate extends through the slot.

13. The dispensing device of claim 11, wherein the dispensing module further comprises a rotating shaft and a rotating member, the rotating member is secured to the cabinet, and the rotating shaft is rotatably mounted to the rotating member; the first blocking plate and the second blocking plate are secured to the rotating shaft; and the rotating member rotates the first blocking plate and the second blocking plate through the rotating shaft.

14. The dispensing device of claim 13, wherein the first blocking plate and the second blocking plate are located on opposite sides of the rotating shaft.

15. The dispensing device of claim 11, wherein the first blocking plate is substantially parallel to the second blocking plate.

16. The dispensing device of claim 11, wherein a distance between the blocking plate and the second blocking plate is substantially equal to a width of each of the plurality of products.

17. The dispensing device of claim 11, wherein the cabinet further comprises a first side plate and a second side plate for the placing of the plurality of products therebetween; and the bottom plate extends slantingly from the second side plate.

18. The dispensing device of claim 17, further comprising a limiting plate extending slantingly from the first side plate, wherein a first column of products is stacked on the limiting plate, a second column of products is stacked on the bottom plate, and the first column of products has a tendency to move to the second column of products.

19. The dispensing device of claim 18, wherein the limiting plate extends slantingly towards the second side plate, and an obtuse angle is defined between the limiting plate and the second side plate.
